(19) United States
(12) Patent Application Publication
(10) Pub. No.: US 2025/0220283 A1
(43) Pub. Date: Jul. 3, 2025

(54) Interactive Media Gaming Platforms, Systems, and Methods for Providing Time-Based Gaming Experiences Integrated/Synchronized with Media/Movie/Music Events

(71) Applicant: Swank Motion Pictures, Inc., St. Louis, MO (US)

(72) Inventor: Jonathan GIALLANZO, St. Louis, MO (US)

(21) Appl. No.: 19/087,207

(22) Filed: Mar. 21, 2025

Related U.S. Application Data
(63) Continuation of application No. PCT/US2024/059387, filed on Dec. 10, 2024.
(60) Provisional application No. 63/613,045, filed on Dec. 20, 2023.

(51) Int. Cl. H04N 21/81

(52) U.S. Cl. CPC H04N 21/8173

(57) ABSTRACT

Exemplary embodiments are disclosed of platforms, systems, and methods for providing time-based gaming experiences integrated/synchronized with media/movie/music events or other media presentations. In exemplary embodiments, a synchronized, event-driven gaming system or platform is configured to be operable for integrating interactive gameplay with concurrently presented media content.

### CROSS-REFERENCE TO RELATED APPLICATIONS

This application is a continuation of PCT International Application No. PCT/US2024/0598387 filed Dec. 10, 2024 that claims priority to and the benefit of U.S. Provisional Patent Application No. 63/613,045 filed Dec. 20, 2023. The entire disclosures of the above applications are incorporated herein by reference.

### FIELD

The present disclosure generally relates to network-based interactive platforms, and more particularly relates to synchronized, event-driven gaming systems, platforms, and methods that integrate interactive gameplay with concurrently presented media content.

### BACKGROUND

This section provides background information related to the present disclosure which is not necessarily prior art.

Traditional media presentations, such as movies, television broadcasts, and other audiovisual content, typically offer passive viewing experiences. As recognized herein, there is a need to enhance audience engagement by synchronizing gameplay or other interactive features with the timing of events occurring within the media.

### DRAWINGS

The drawings described herein are for illustrative purposes only of selected embodiments and not all possible implementations, and are not intended to limit the scope of the present disclosure.

FIG. 1 illustrates an exemplary system architecture and connected elements of a platform or system according to exemplary embodiments of the present disclosure.

FIG. 2 is a block diagram depicting an example workflow for creating a game according to exemplary embodiments of the present disclosure.

FIG. 3 is a block diagram depicting an example workflow for entering a game according to exemplary embodiments of the present disclosure.

FIG. 4 is a table listing possible types of games and scenarios that may be implemented in exemplary embodiments of the platforms, systems, and methods disclosed herein.

FIGS. 5 through 10 are graphical user interface screenshots of an Administration Web Portal according to exemplary embodiments of the present disclosure.

FIGS. 11A, 11B, and 11C include end user screenshot examples while playing bingo on a mobile device (e.g., smartphone, tablet, etc.) according to exemplary embodiments of the present disclosure.

FIGS. 12 and 13 are graphical user interface screenshots of an Administration Web Portal while setting up a trivia game according to exemplary embodiments of the present disclosure.

FIGS. 14A, 14B, 14C, 14D, 14E, and 14F include end user screenshot examples while playing a trivia game on a mobile device (e.g., smartphone, tablet, etc.) according to exemplary embodiments of the present disclosure.

FIG. 15 includes an example feedback pop up that may be displayed at the end of a trivia game to capture a rating and text feedback on the gaming experience.

### DETAILED DESCRIPTION

Example embodiments will now be described more fully with reference to the accompanying drawings.

As noted above in the background, traditional media presentations, such as movies, television broadcasts, and other audiovisual content, typically offer passive viewing experiences. As recognized herein, there is a need to enhance audience engagement by synchronizing gameplay or other interactive features with the timing of events occurring within the media. As further recognized herein, such synchronization can be achieved by leveraging network connectivity and mobile devices to provide a shared, communal experience without requiring end users to install specialized applications or create user accounts.

Exemplary embodiments are disclosed herein that include a system or platform (also referred to herein as the “Screenplay Platform”) configured to be operable for providing a network-based gaming environment in which various forms of media, such as movies, television programs, or other streamed or broadcast content, are synchronized with interactive gameplay features accessible on mobile devices. The disclosed platform can be implemented using a wireless network (including the Internet or a closed Wi-Fi network) and requires that end users have access to the media at a specified time. The platform is device-agnostic and requires only that end users have a smartphone with a standard web browser; no dedicated application download or user login is required.

In operation, one or more administrators create games associated with particular media content and assign specific gameplay actions to events within the media's timeline. For example, in a “bingo”-style game, a selectable area on a grid (i.e., a bingo square) may become “markable” only when the corresponding event in the media occurs at a predetermined timecode. In a trivia-style game, a question may appear on the users' mobile browsers at a designated time, allowing users to answer in real-time as they watch the media. By aligning these gameplay triggers with timecodes in the media presentation, the platform provides a synchronized, interactive experience.

End users access the game by scanning or otherwise receiving a link (e.g., via a QR code, etc.) provided by an administrator or event organizer. When the end user follows the link on their smartphone's browser, the platform initiates the gameplay session. Each new game session is associated with a specified start time and date, corresponding to when the media presentation commences. This synchronization ensures that interactive events occur at the correct moments during the media presentation, enhancing audience engagement and creating a communal experience.

### 1. System Components

The following is a description of system components including (media presentation, network connectivity, end user devices, and platform server) that may be included in exemplary embodiments disclosed herein.

Media Presentation: The media may be a feature film, television show, recorded event, live broadcast, or any other time-based audiovisual content. The media presentation is presented in a shared environment, such as a theater, auditorium, or other venue, where multiple end users can view the same media simultaneously.

Network Connectivity: The system relies on a wireless network connection, which can be a public or private Wi-Fi network, cellular data network, or other form of wireless connectivity. This network provides a communication channel between the end user smartphones and a platform server that manages gameplay events.

End User Devices: Each end user possesses a smartphone (e.g., Android or iOS, etc.) equipped with a camera and a standard web browser. No additional applications need to be installed, and no login credentials are required. The smartphone's browser is used to access the gameplay interface via a URL or QR code link.

Platform Server: A remote server or set of servers host the Screenplay Platform. The server stores and manages game configurations, timecodes mapped to media events, and user interactions. The Platform Server also generates unique QR codes or shareable links for each game session. When an end user accesses the link, the server provides a browser-based interface that displays interactive elements synchronized with the media timeline.

### 2. Game Creation and Administration

The following is a description of the game creation and administration (including the administrator role, mapping events to timecodes, and generation of game links) that may occur in exemplary embodiments disclosed herein.

Administrator Role: An administrator, event organizer, or designated content creator uses an administrative interface to configure games associated with one or more media presentations. The administrator sets a specific date and time for the media to start, ensuring temporal synchronization between the platform's gameplay elements and the media's events.

Mapping Events to Timecodes: The administrator identifies key events within the media (e.g., a particular scene, dialogue, visual cue, sound effect, or storyline moment, etc.) and assigns the identified key events to corresponding gameplay actions and triggers. For example, at a predetermined timecode corresponding to when a particular scene occurs in the media, a bingo square on each end user's device becomes selectable. In a trivia game, a question might appear when the media reaches a certain timestamp, prompting end users to answer before a deadline expires.

Generation of Game Links: Once the game configuration is complete, the administrator obtains a unique URL or QR code. This code is shared with the audience (end users) who will participate in the game. The code can be displayed on-screen within the venue, printed on promotional materials, or otherwise distributed.

### 3. End User Interaction

The following is a description of the end user interaction (including accessing the game, gameplay interface, synchronizing with the media) that may occur in exemplary embodiments disclosed herein.

Accessing the Game: End users use their smartphones to scan the provided QR code or to click the shared URL. Upon accessing this link, the browser loads the interactive gameplay interface from the platform server.

Gameplay Interface: The gameplay interface can include visual elements such as a bingo card, trivia questions, polls, or other interactive tools. These elements are initially in a non-interactive or locked state until the corresponding media events occur at the assigned timecodes.

Synchronizing with the Media: As the media plays in the shared venue at the designated start time, the platform server tracks its progress relative to known timecodes. When the media reaches a configured event time, the server updates the gameplay interface on the users' devices. For example, a bingo square changes state to allow marking, or a trivia question becomes visible and interactive. In this manner, end users participate in the game concurrently and in real-time, interacting directly with their smartphones.

### 4. No Dedicated Application or Authentication Required

The platform eliminates the need for end users to download dedicated applications or register for accounts. This approach ensures a frictionless experience, allowing immediate participation as long as the end users have access to the shared media event and the provided network link or QR code.

The following is a description of an example usage or implementation of the Screenplay Platform including the following elements and scenario:

1. Each end user attending a movie screening in a theater or similar venue has a smartphone (Android or iOS) equipped with a camera and a web browser.

2. A feature film is presented to an audience assembled in a shared physical space, such as a theater or auditorium.

3. A wireless network (either a Wi-Fi network or a cellular data network) is accessible to all end users' smartphones.

4. The game's QR code is displayed to all end users in the theater. Each end user can scan this QR code with their smartphone's camera to access the corresponding game link. Upon doing so, the gameplay interface appears in the smartphone's browser and is automatically synchronized with the timing of events in the film.

5. In this example implementation/usage, all participants experience the media simultaneously. And the synchronized gameplay features enrich the viewing experience by allowing real-time interaction keyed to specific moments within the media.

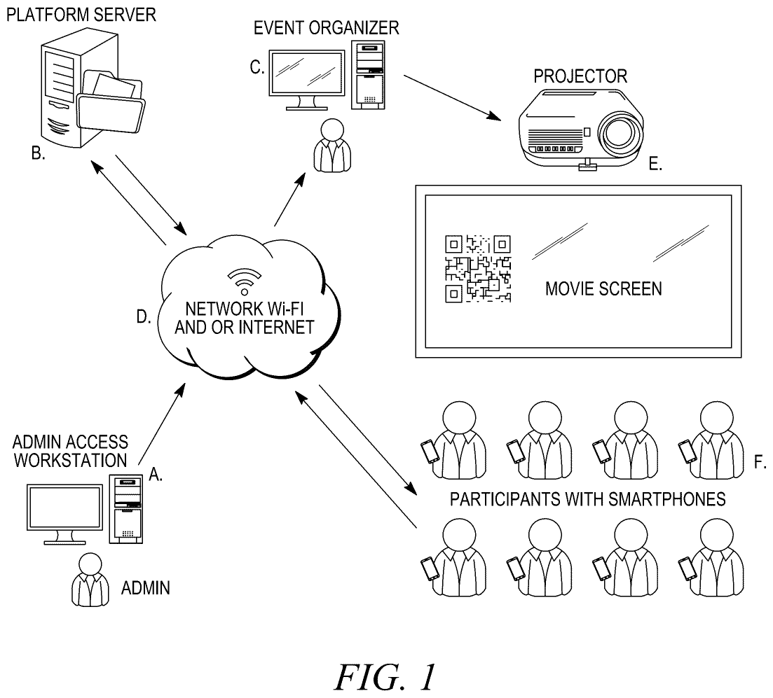

With reference to the figures, FIG. 1 illustrates an exemplary system architecture and connected elements of an interactive media gaming platform or system according to exemplary embodiments of the present disclosure. Shown in FIG. 1 are Administrator (A), Platform or Screenplay Server (B), Event Organizer (C), Computer Network (D), and Participants (E). Below are descriptions of the features A through E of this exemplary system architecture.
A. Administrator—browser based access to platform with access and controls to Create/Edit/Delete/Distribute games Access to usage reports and feedback data.
B. Platform or Screenplay Server—SQL/Web Server than runs the Screenplay application to create/edit/distribute games created by Administrator (A).
C. Event Organizer—Customer that is coordinating and running the movie screening at the location.
D. Computer network—Wireless network either closed or open, Wi-Fi or cellular based.
E. Screening Location—Projector and Movie Screen showing the movie title.
F. Participants—Participants at the screening with smartphones that can access the network (D) and the gaming experience.

The following describes an example use or workflow of the exemplary system architecture shown in FIG. 1.
1. Administrator (A) creates or selects a game
2. Administrator (A) creates a game link generated on Platform on Screenplay Server (B) through Computer Network (D) thru to Event Organizer (C)
3. Event Organizer (C) creates a game instance (time, date, QR code) with the link provided by Administrator (A)
4. Event Organizer (C) shares the QR code on the Movie Screen of the Screening Location (E) for the users or participants (F) to access
5. The users or participants (F) or users enter the game, which starts on the pre-determined time created by Event Organizer (C)

Disclosed herein are exemplary embodiments of interactive media gaming platforms, systems, and methods for providing time-based gaming experiences integrated/synchronized with media/movie/music events (broadly, media presentations), such as movie screenings, classroom presentations, auditory events, visual presentations, movies, television programs, or other streamed or broadcast content, other forms of media, other media/movie/music events, etc. In exemplary embodiments, a synchronized, event-driven gaming system or platform is configured to be operable for integrating interactive gameplay with concurrently presented media content. In exemplary embodiments, one or more user(s) may play a game on a mobile device(s) (e.g., smartphone, tablet, etc.) to interact with the media/movie/music events in real-time while playing the game that is integrated/synchronized to the media/movie/music event.

Exemplary embodiments disclosed herein include a platform configured to provide a mobile solution that empowers end users to engage with media/movie/music and content independently of the platform. The platform is configured to operate on a login-free model, accessible through mobile web browsers without the need for a dedicated app.

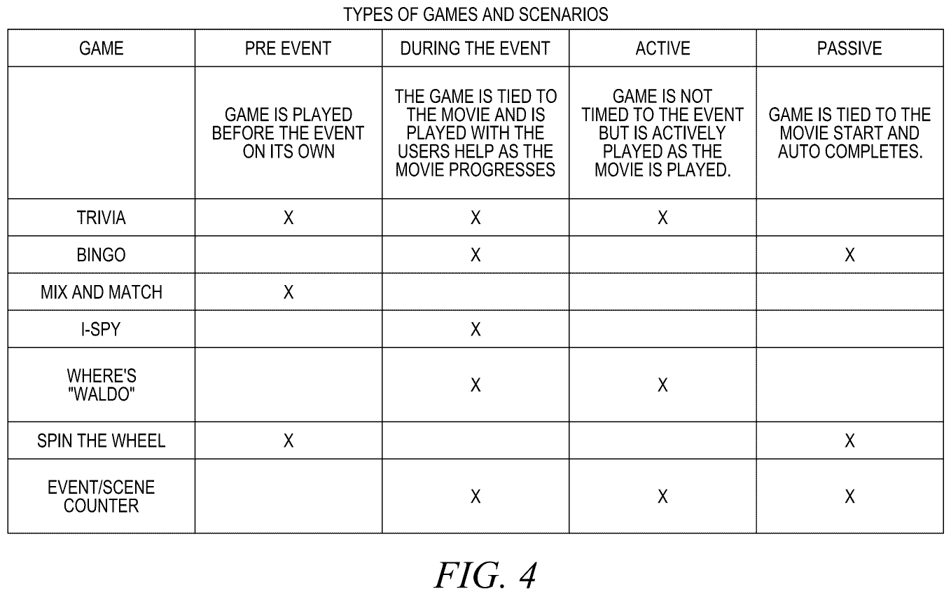

The platform is configured to provide the distinctive ability to offer real-time gaming experiences, such as Bingo, Trivia, Fill-in-the-Blank, Question and Answer (Q&A), other games listed in FIG. 4, etc., seamlessly integrated with media/movie/music events, including but not limited to movie screenings, classroom presentations, auditory events, visual presentations, etc. at any suitable location (e.g., movie theaters, school classrooms, gymnasiums, auditoriums, hospitals, private rooms, cruise ships, correctional facilities, remote learning locations, healthcare, hospitality, transportation, etc.). The gamified experiences are synchronized with the media/movie/music or other content being presented. By way of example, a media gaming platform disclosed herein may be used in-room at a hospital such that hospital patient(s) can participate in their own room when they launch a QR code shown on a TV channel and the movie starts thereafter. By way of further examples for the platform disclosed herein, other types of remote disconnected game play use cases other than an in-person event include Correctional, Remote Learning, Healthcare, Hospitality, transportation, etc.

In exemplary embodiments, the platform preferably does not control or initiate the media/movie/music or other content playback. Instead, the platform preferably only synchronizes to a specific start time to provide a synchronous mobile experience.

In exemplary embodiments, the users participating in the games are not required to install any dedicated applications or create user accounts. Instead, the user(s) can join a game via a URL or QR code, tailoring their gaming experience to their preferences. Furthermore, the platform can anonymously identify game winners and rankings, thru a “nickname” moniker entered into the platform by the user at the start of gameplay. The platform is preferably designed to scale efficiently, providing administrators with a single uniform URL to deploy for multiple games that can run concurrently and asynchronously while meticulously tracking the progress of each game.

The platform is configured to utilize pre-determined timecodes entered on the platform to synchronize specific gaming events for players on their mobile devices. These events are pre-loaded into the platform's Administration Web Interface for each type of game that can be deployed. The platform can also operate in totally disconnected environments from the Internet, making it suitable for closed networks, such as cruise ships and remote locations with little or no Internet Connectivity. In exemplary embodiments, the platform is configured such that the only requirement is a Wi-Fi network to link gameplay.

In exemplary embodiments, the games are saved and run to a set point in time, which is determined when the game is set up. The ability to replay the same game is not available, as once the start time has passed, then the game is active, hence the specific QR code. In order to replay a game, a new game event and start time is created with a new QR code. The game is saved (game list) and can be re-entered if the need arises when a player might lose connection or restart the player's smartphone or other mobile device, as long as the movie/media/music event has not ended. The returning player can re-enter the game with the same QR code and pick up where the returning player left off.

In exemplary embodiments, the leaderboard is specific to the specific game event, e.g., December 10^{th} at 7 pm will have a specific game “winner” or list of ranked players. That leaderboard is siloed from all other games' winners or leaderboards.

In exemplary embodiments, the saved games may be captured to determine how many players used the game at an event and their participation, though anonymous. This information may be provided to the customer that booked the title for the movie screening or other media/movie/music event. Accordingly, exemplary embodiments may be configured to capture this return on investment (ROI) metric at high level.

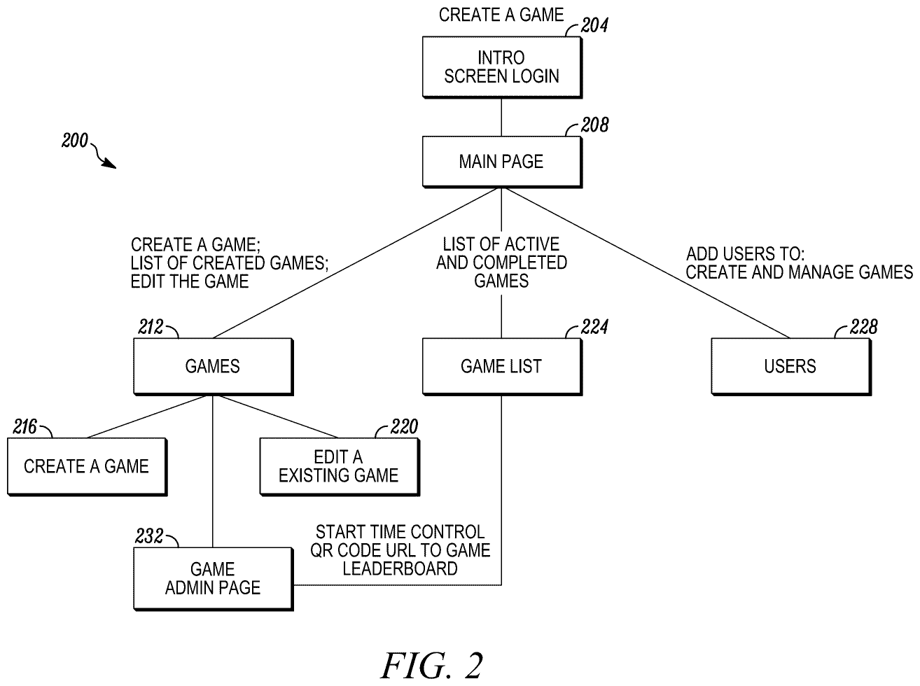

FIG. 2 is a block diagram depicting an example workflow 200 for creating a game including an Intro Screen Login 204;
Main Page 208;
Games 212 (providing options to create a game 216, to review list of created games, edit an existing game 220);
Game List 224 (providing options to display list of active and completed games);
Users 228 (add users to create and manage games); and
Game Admin Page 232 (providing admin options including start time control, QR code, URL to game, and leaderboard).

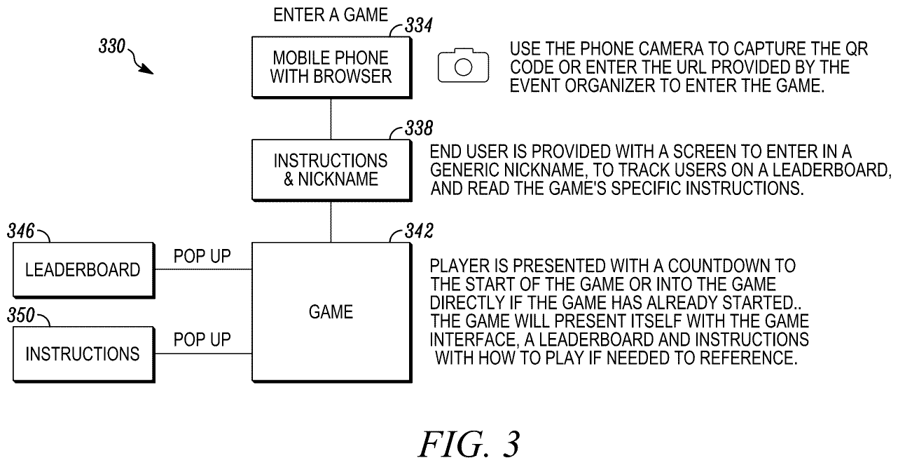

FIG. 3 is a block diagram depicting an example workflow 330 for entering a game including:
Mobile Phone or other device with a browser 334 (mobile device camera is used to capture the QR code or enter the URL provided by the event organizer to enter the game);
Instructions and Nickname 338 (end user is provided with a screen to enter in a generic nickname, track users on a leaderboard, and read the game's specific instructions);
Game 342 (Player is presented with a countdown to the start of the game or into the game directly if the game has already started. The game will present itself with the game interface, a leaderboard and instructions with how to play if needed to reference); and
Leaderboard Popup 346 and/or Instructions Popup 350.

FIG. 4 includes a table listing possible types of games and scenarios that may be implemented in exemplary embodiments of the interactive media gaming platforms, systems, and methods disclosed herein. The list of example games include Trivia, Bingo, Mix and Match, I-Spy, Where's “Waldo”, Spin the Wheel, and Event/Scene Counter. The example scenarios include Pre Event, During the Event, Active, and Passive. For the Pre Event scenario, the game is played before the event on its own. For the During the Event scenario, the game is tied to the media/movie/music event and is played with the user's help as the event progresses. For the Active scenario, the game is not timed to the event but is actively played as the movie or other media/music event is played. For the Passive scenario, the game is tied to the event start and auto completed.

As shown in FIG. 4, Trivia may be played under or according to the Pre Event, During the Event, and Active scenarios. Bingo may be played under or according to the During the Event and Passive scenarios. Mix and Match may be played under or according to the Pre Event scenario. I-Spy may be played under or according to the During the Event scenario. Where's “Waldo” may be played under or according to the During the Event and Active scenarios. Spin the Wheel may be played under or according to the Pre Event and Passive scenarios. Event/Scene Counter may be played under or according to the During the Event, Active, and Passive Scenarios.

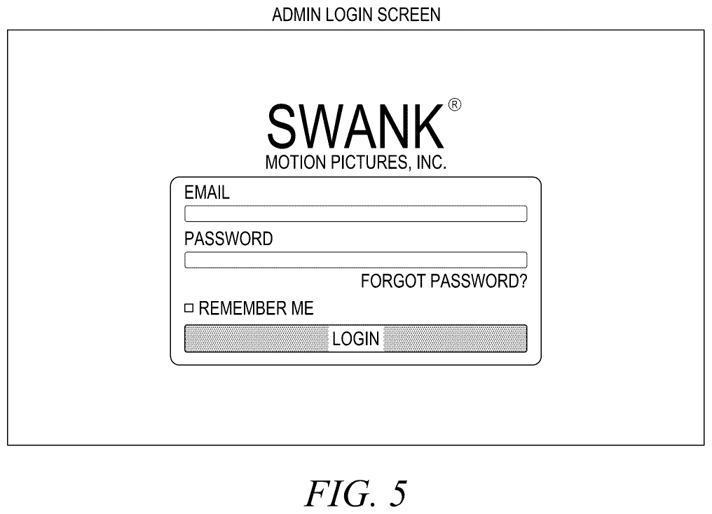

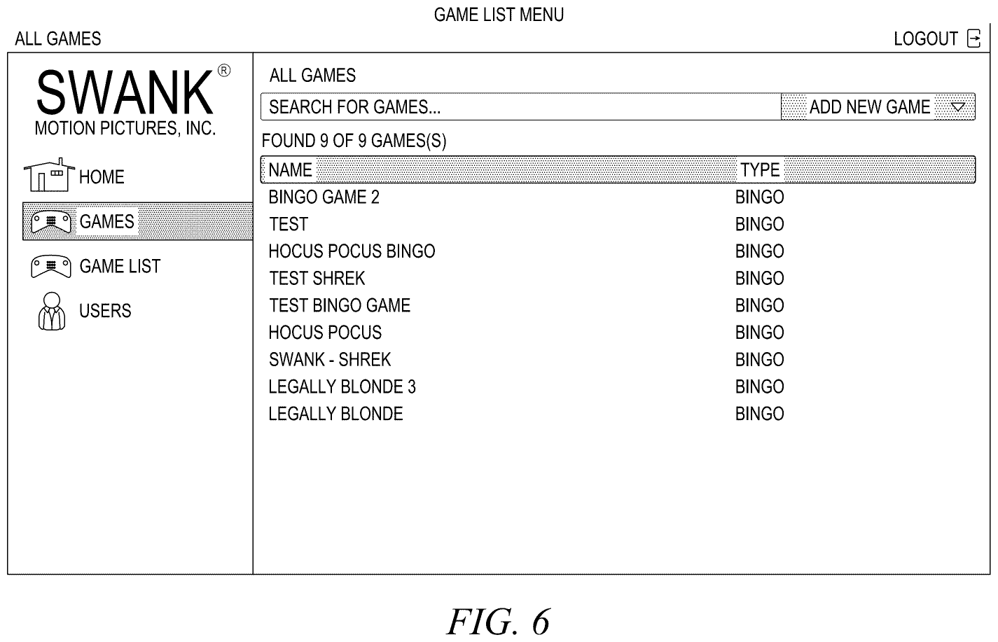

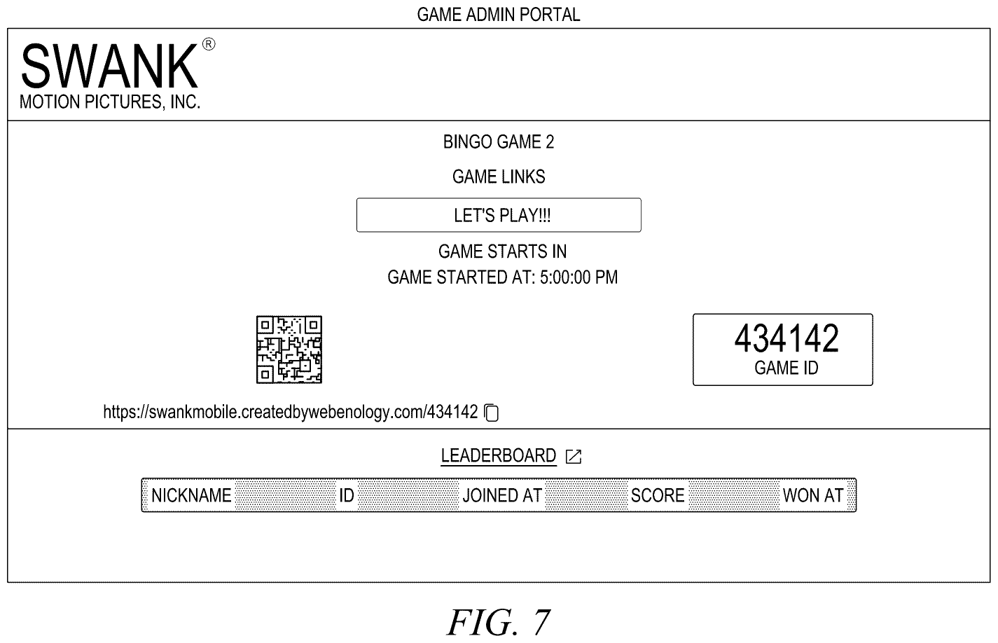

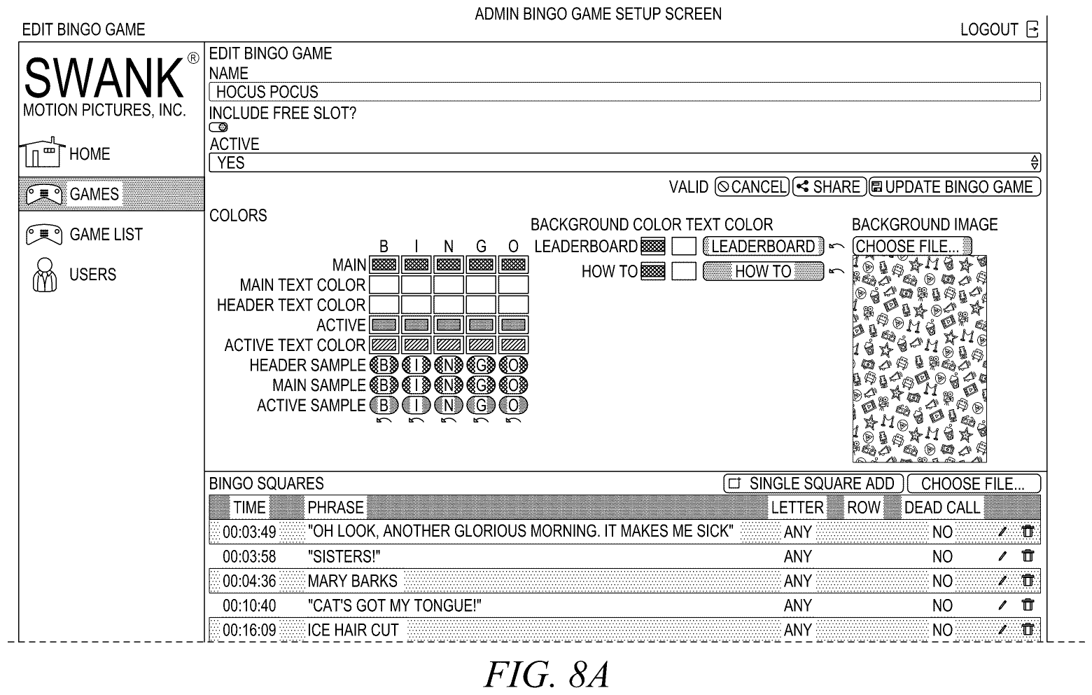

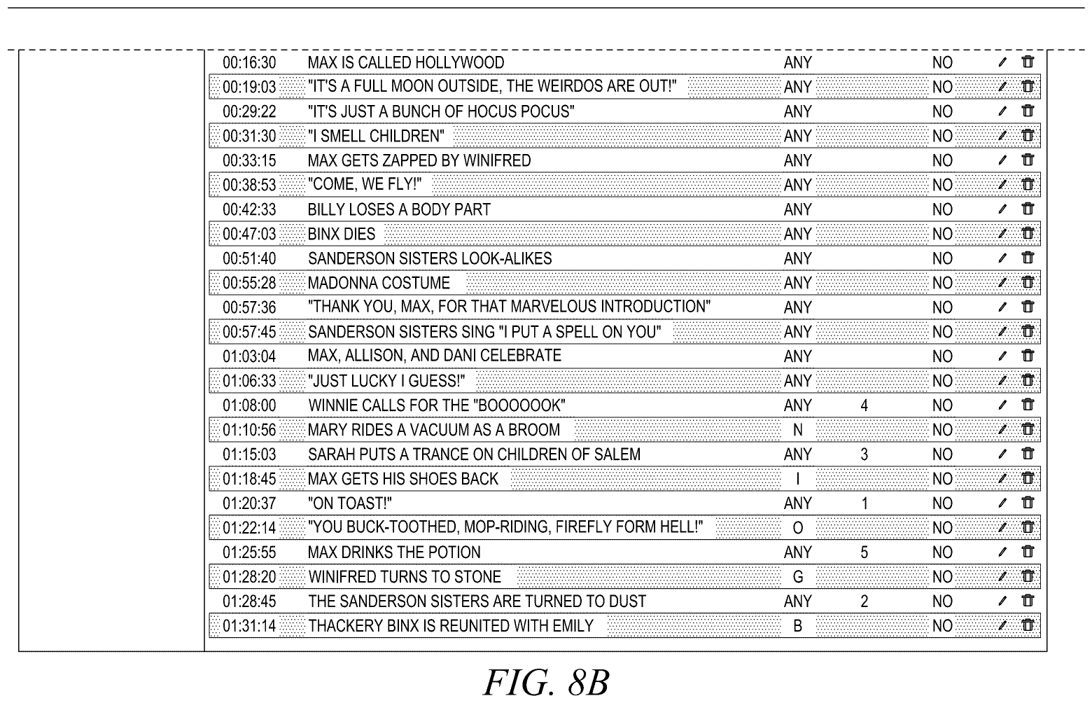

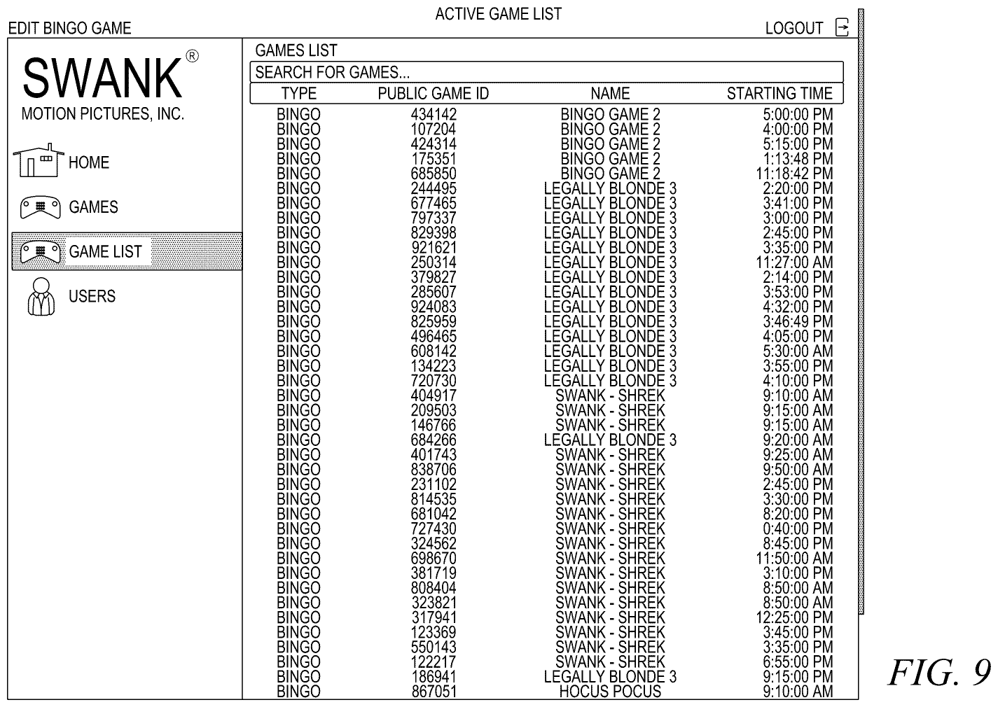

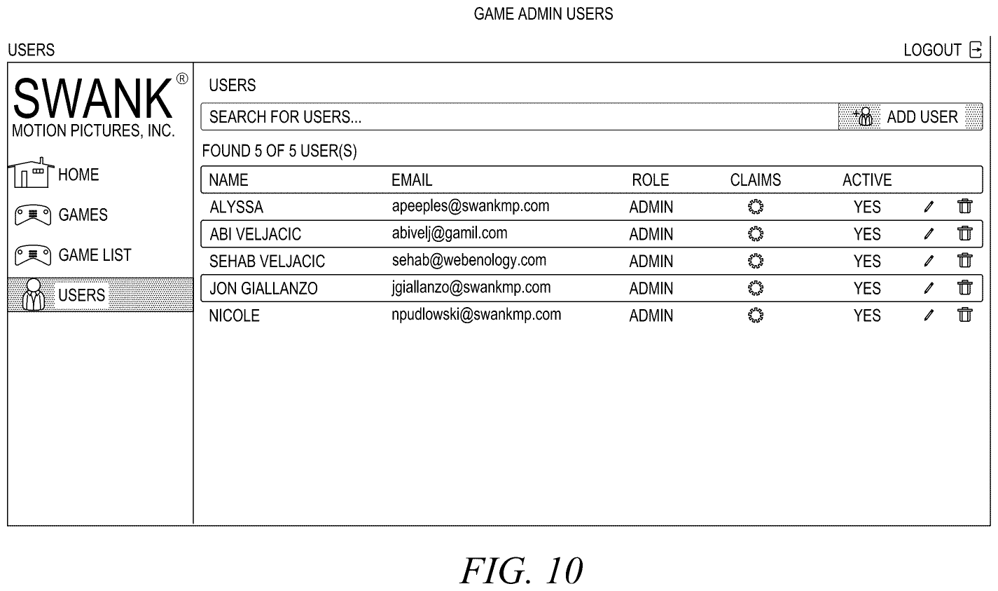

FIGS. 5 through 10 are graphical user interface screenshots of an Admin Web Portal according to exemplary embodiments of the present disclosure. More specifically, FIG. 4 is a screenshot showing an Admin Login Screen for entering a username and password to login. FIG. 5 is a screenshot showing a Game List Menu. FIG. 6 is a screenshot showing a Game Admin Portal including a QR code and URL link to the game, and the Game ID (e.g., 434142). FIG. 7 is a screenshot showing an Admin Bingo Game Setup Screen. FIG. 8 is a screenshot showing an Active Game List. FIG. 9 is a screenshot showing Game Admin Users.

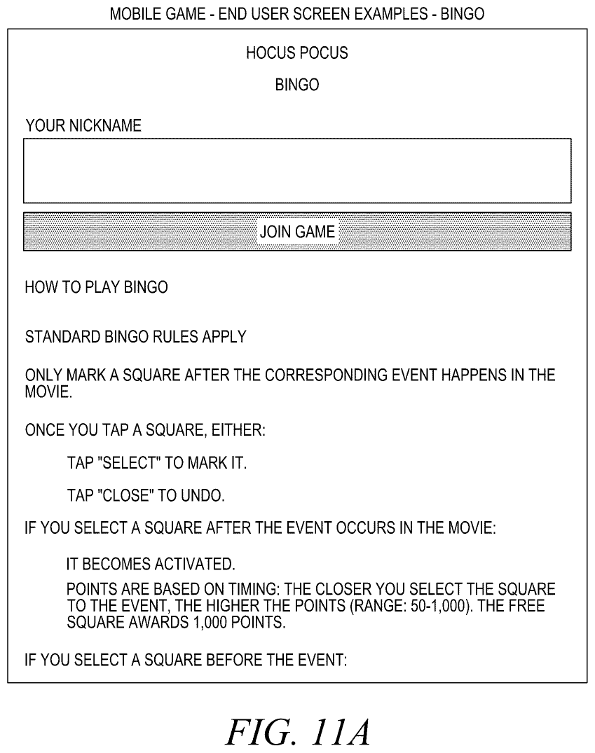

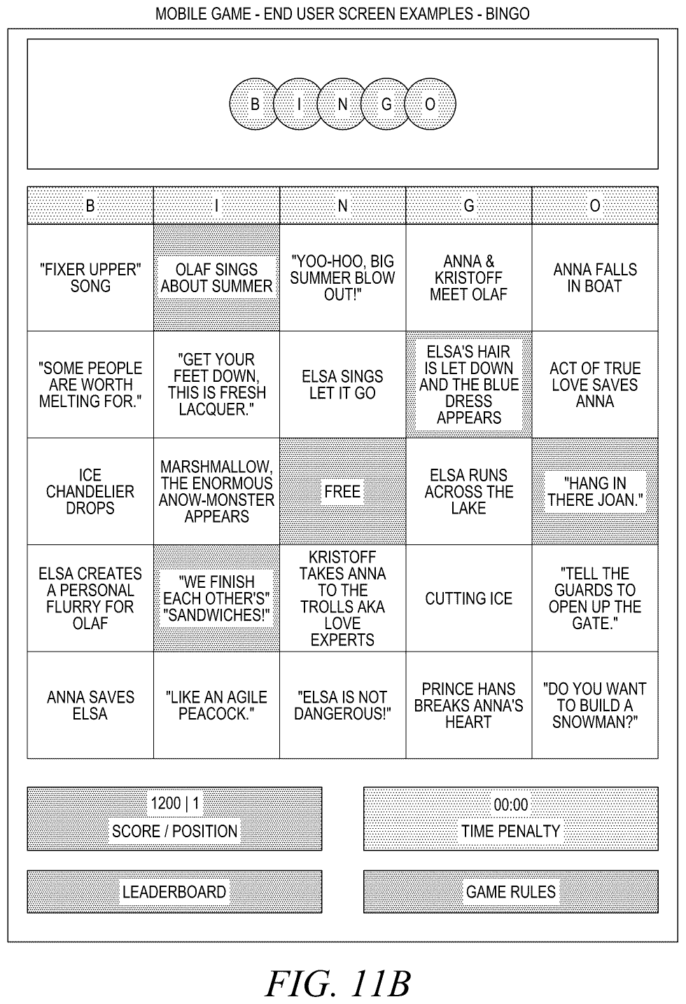

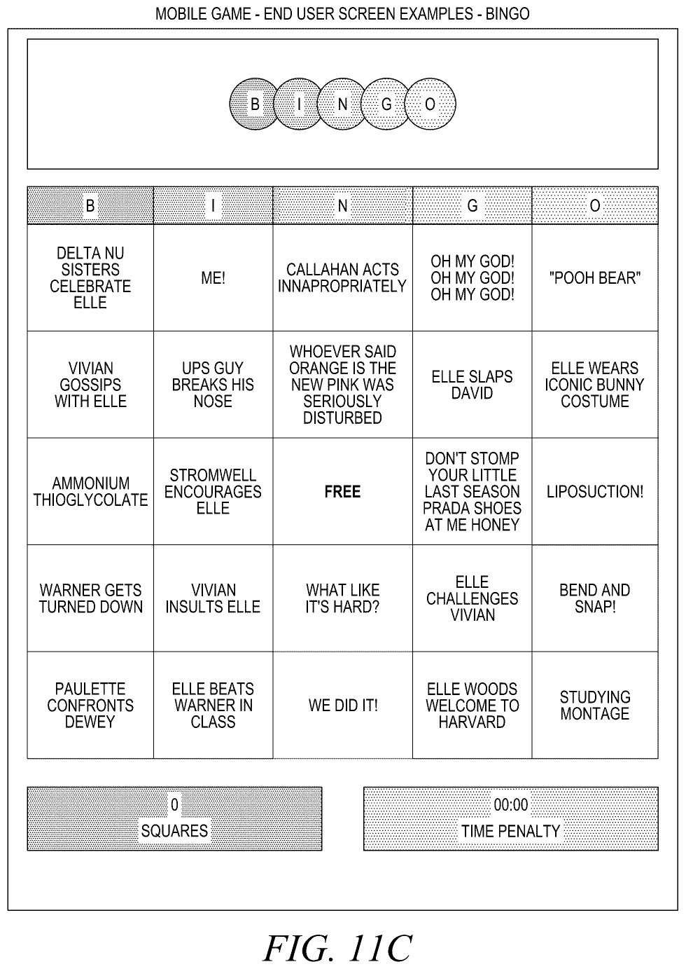

FIGS. 11A, 11B, and 11C include end user screenshot examples while playing bingo on a mobile device (e.g., smartphone, tablet, etc.) according to exemplary embodiments of the present disclosure. More specifically, FIG. 11A is an example screenshot before the end user begins playing a game of Hocus Pocus bingo on a mobile device while watching the movie Hocus Pocus. FIG. 11B is an example screenshot showing a bingo game card that may be played while watching the movie Frozen. FIG. 1 IC is an example screenshot showing a bingo game card that may be played while watching the movie Legally Blond.

As shown in FIG. 11A, the end user is prompted to first enter a nickname before joining the game. FIG. 11A also includes the standard bingo rules on how to play the bingo:
Only mark a square (e.g., by tapping the square on the mobile device touchscreen, etc.) after the corresponding event happens in the movie.
Once the user taps a square either:
   Tap “Select” to mark it; or
   Tap “Close” to undo.
If you select a square after the event occurs in the movie:
   It becomes activated; and
   Points are based on timing: the closer you select the square to the event, the high the points (e.g., points range from 50 to 1,000 points, etc.). The free square awards maximum points (e.g., 1,000 points, etc.).
If you try to select a square before the event happens, the square will not be selected and a time penalty (e.g., 30 seconds, etc.) will be assigned for each bad selection. Even if the end user has bingo, the end user cannot call bingo until the penalty timer expires.

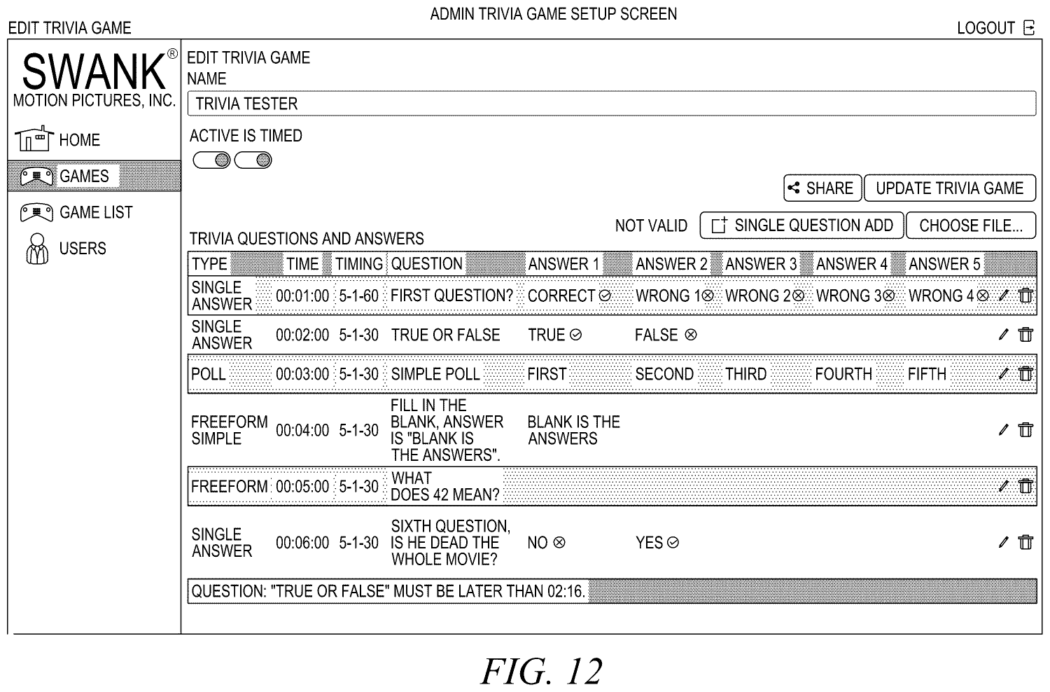

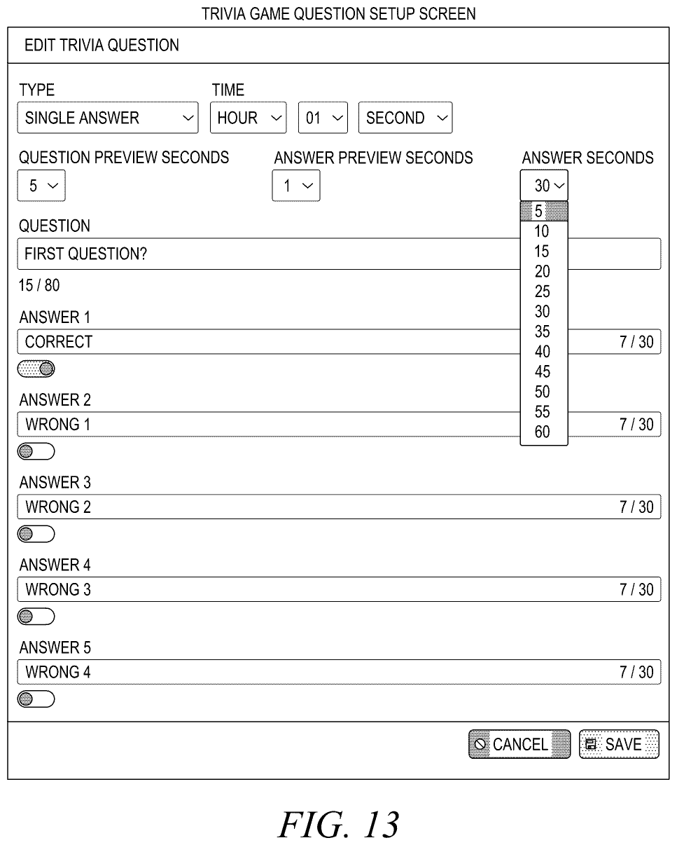

FIGS. 12 and 13 are graphical user interface screenshots of an Administration Web Portal while setting up a trivia game according to exemplary embodiments of the present disclosure. More specifically, FIG. 12 is a screenshot showing an Admin Game Setup Screen. FIG. 8 is a screenshot showing an Active Game List. FIG. 13 is a screenshot showing a Trivia Game Question Setup Screen.

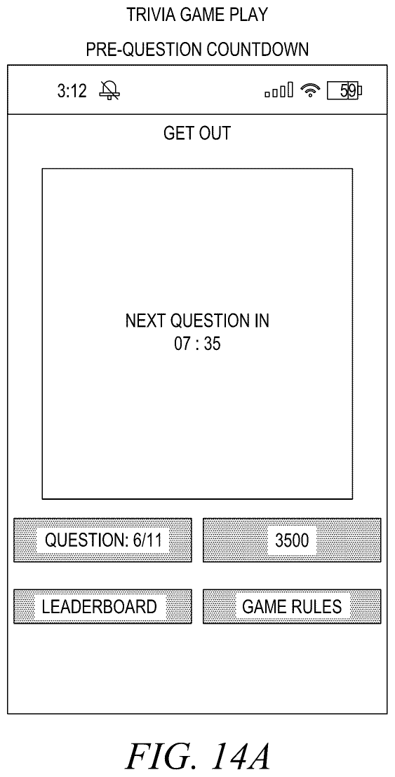

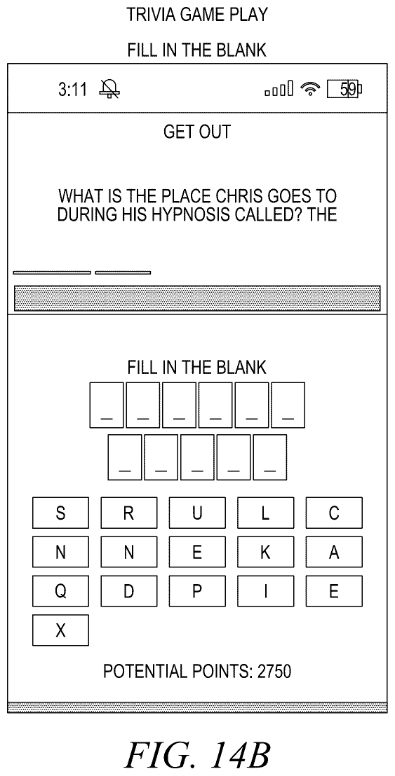

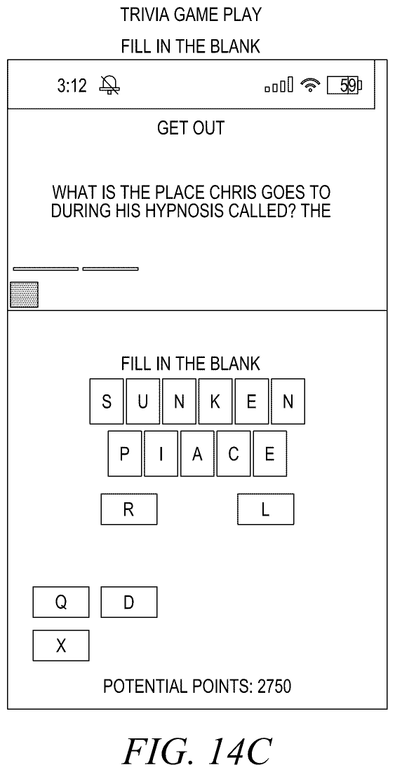

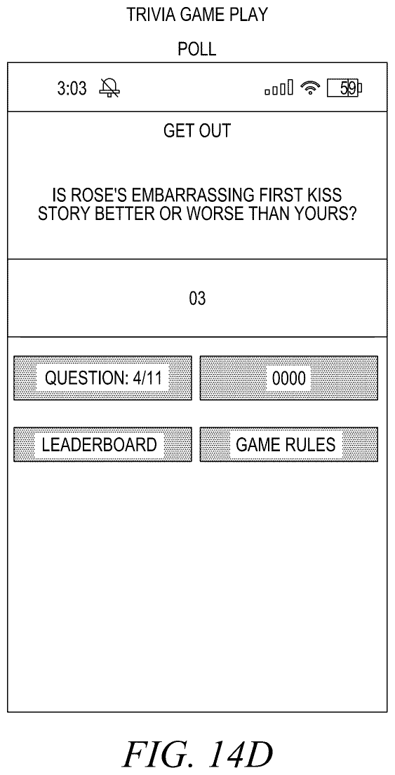

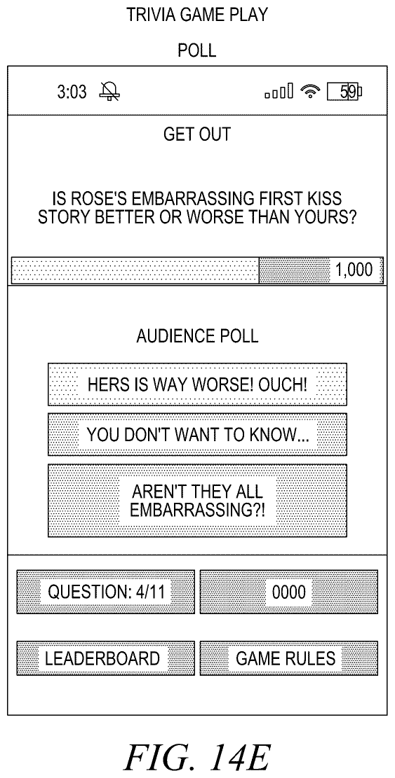

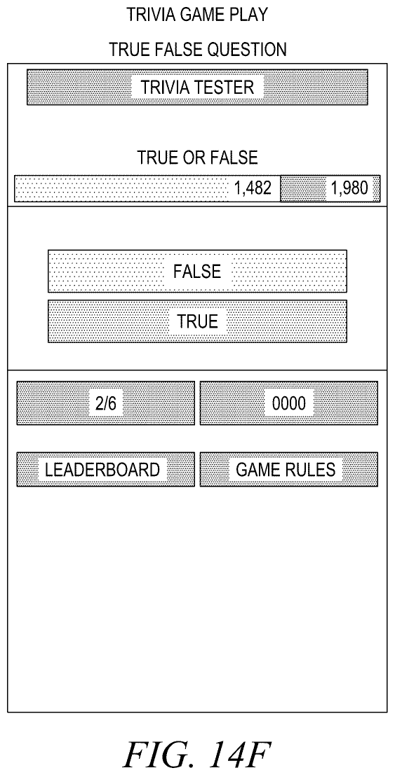

FIGS. 14A, 14B, 14C, 14D, 14E, and 14F include end user screenshot examples while playing a trivia game on a mobile device (e.g., smartphone, tablet, etc.) according to exemplary embodiments of the present disclosure. More specifically, FIG. 14A is an example screenshot of a pre-question countdown that may displayed to the end user while playing a trivia game on a mobile device while watching the movie Get Out. FIGS. 14B and 14C are example screenshots showing an example fill in the blank question that may be asked during a trivia game while watching the movie Get Out. FIGS. 14D and 14E are example screenshot showing an example poll question that may be asked during a trivia game while watching the movie Get Out. FIG. 14F is an example screenshot showing an example true false question that may be asked during a trivia game while watching the movie Get Out.

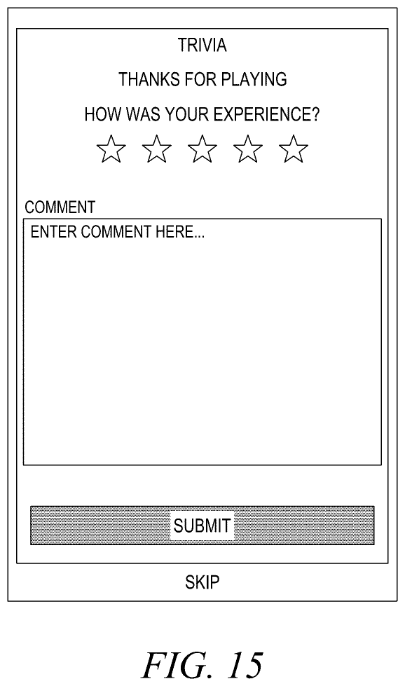

In exemplary embodiments, a feedback pop up may be displayed at the end of gameplay to capture a rating and text feedback on the gaming experience. See, for example, FIG. 15 showing an example feedback pop up that may be displayed at the end of a trivia game to capture a rating and text feedback on the gaming experience.

In some exemplary embodiments, the platform or system is configured to have the following example Bingo/Trivia capabilities and/or features for providing time-based gaming experiences integrated/synchronized with media/movie/music events (broadly, media presentation), such movie screenings, classroom presentations, auditory events, visual presentations, etc.

In the examples below, the time periods may be variable and determined when the game is created.
Operates on mobile devices
Scalable
Low touch for administrators
Increase attendance and audience engagement
Winner takes mobile device to attendant to verify winning game

### Trivia

Pre-movie trivia game is timed and has only enough questions for a certain time period
During the movie, trivia game is synchronized to the movie time and moves to the next question when the timestamp has been reached
   1. If a question is scheduled to show up at 15 minutes into the movie, that question will show up around 15 minutes after the start of the game per device because system is not keeping track of when the movie is started only when the game has started.
After the movie, trivia game mirrors the pre movie trivia

### Trivia Instructions: How to Play Trivia

The game will start automatically once the countdown ends, followed by a countdown to the first question.
Between questions, there will be a countdown to when the next question is presented.
Tip: Turn off auto-lock and lower screen brightness to avoid missing questions and creating distractions.
The leaderboard and instructions can be viewed at any time using the buttons at the bottom of the page. You can also see which question you are on out of the total question count.
There are four types of questions with varying point values and timings.
Multiple Choice Trivia Questions: Select the correct answer quickly for maximum points. Points are awarded based on how quickly the correct answer is selected. You can change your answer, but it will affect your possible points. You have 30 seconds to answer (e.g., or other time limit determined when the trivia game is created).
Audience Polls: No right or wrong answers; everyone gets points for participating. You can see poll results from audience afterward. You have 30 seconds to answer (e.g., or other time limit determined when the trivia game is created).
Fill in the Blank: From the correct answer using provided letters. Points are awarded for each correct letter in the correct spot. You have 60 seconds to answer (e.g., or other time limit determined when the trivia game is created). Tip: Even if you do not know the answer, you are better off putting anything down instead of leaving it blank.
Free Answer: Type in your answer. No right or wrong answers; everyone gets points for participating. You have 60 seconds to answer (e.g., or other time limit determined when the trivia game is created).
Before each question, you will see a preview and a countdown. After timer is up, you will see the correct answer (if applicable) or poll results, followed by the updated leaderboard.
The final leaderboard will display after the last question as well as your final position.
Each trivia question pops up and audience member sees a timer that counts down (e.g., 10-second timer, other timer determined when the trivia game is created).
The question is shown when the timer hits a determined time (e.g., 5 seconds, other time determined when the trivia game is created).
After 5 seconds, the answers show up and there is a 1 to 1.5 second timeout for the audience to get full points.
A minimum of 30 second pause between questions.
Questions have to be answered within a predetermined time when the trivia game is set up (e.g., 30 seconds, more or less than 30 seconds) and as time elapses, decrease the points possible.
If wrong answer is selected, cut the points in half.
If all wrong answers selected, award 0 points and move on to the next trivia question.
During the movie trivia, questions will be shown based on time in sequence.
Questions for before or after the movie can be randomized and answer locations randomized as well.
Winner is person with most points.
Winner will take mobile device to organizer to verify if they have won or not.
Minimum score may be created to get to be a winner.

### Bingo

Movie themed bingo (sync to time of when bingo game has started)
General themed bingo (answers must be tailored to the movie genre)
Two ways of playing bingo, get 5 in a row or blackout bingo
Rules for themed bingo
   1. Clicking on correct answer at or after the time in plot highlights the cell with +/−2 to 5 minute window
   2. Clicking on wrong plot point shows error message
      1^{st} time we give them a notification letting the audience member know that next wrong answer will add a 30 second penalty
      Clicking wrong answer 2^{nd} and subsequent time will add 30 second penalty to bingo game
   3. Bingo penalty
      If audience member wins bingo they will see a timeout of X amount of time in seconds before they can click “Call Bingo” button
         All Bingo games are randomized for each audience member
         Can add “dead cells” to bingo if want everyone to play until the end
         Dead cells would only show up at the last 15 minutes of the movie
Rules for general bingo
   1. Same as themed bingo for clicking on wrong squares and penalty is applied the same as explained below.
   2. Changes are that the answers are not time based, but activity based
      E.g., “someone shoots at main character and misses”
      E.g., “Bazooka is used”
   3. Answers have to be timestamped

In some exemplary embodiments, the platform or system is configured to have the following example Trivia capabilities and/or features for providing time-based gaming experiences integrated/synchronized with media/movie/music events (e.g., movie screenings, classroom presentations, auditory events, visual presentations, etc.).
Operates on mobile devices
Scalable
Low touch for administrators
Increase attendance and audience engagement
Winner takes mobile device to attendant to verify winning game

### Trivia and Poll

Two different avenues, entertainment with scores and business without scores
Ability to add in different type of modes per question, modes include:
   1. Multi Answer Trivia
   2. True and False Trivia
   3. Poll
   4. Fill in the Blank
Entertainment
   1. When starting a game, user presented with entering a nickname
   2. “Multi Answer Trivia” and “True, False”
      Pre-movie trivia game is timed and has only enough questions for a certain time period
      During the movie, trivia game is synchronized to the movie time and moves to the next question when the timestamp has been reached
      After the move trivia game mirrors the pre movie trivia
      Can add up to 5 different answers. To achieve true/false questions only add 2 answers.
Rules
   1. Question shows by a variable number of seconds set up by the game designer before the question time
   2. Show a countdown on the answers section
   3. At 0 seconds, show the answers on the screen and have a bar go from right to left with the max amount of points and as the bar goes down decrease the points
   4. Wait 1.5 seconds before the bar starts moving so participants can get full points
   5. Participants can select an answer at any time and lock in their score at the time of selection, example:
      If you select an answer at 90% bar, you lock the score at 90%. And if you select another answer will lock the score at the new level.
   6. After timer runs out, show a bar graph and percentage of the selected answers
      If correct then obtain the locked points, if wrong then 0 points.
      Highlight the correct score with green and if selected the wrong answer will highlight with red
Randomize the answer position, same question for all participants
Winner is person with most points

### “Fill in the Blank”

Game creator will be able to set if it is a one-word answer, two-word answer, three-word answer, or four-word answer or a free text answer up to 120 characters, and will refer to them as fillable answers and free text answers
   1. Fillable answers will have points that get divided by the number of letters and if the participant misses a letter, take away that many points
   2. Fillable answers will show the number of characters that need to be filled by showing underscores per word and letter.
Free form answer will not have a score
Same timing as Multi Answer Trivia
Ability to set the time the question shows
Ability to set the time the question shows before the event time

### “Poll”

Everything applies from “Multi Answer Trivia” except:
   1. No points per poll question
   2. No wrong answer

### For Businesses

No nickname, anonymous play
“Multi Answer Trivia” and “True, False”
   1. Same as entertainment Multi Answer Trivia except
      No score
“Fill in the Blank”
   1. Same as entertainment “Fill in the Blank” except
      No Score
      Show free text answers anonymously to users after submission
“Poll”
   1. Same as entertainment poll

### Turn-Key for Customer

Customer/Organizer will be provided with the game URL
Organizer would go to game URL and “create new game”
Organizer would them be presented with a QR code and a 6 digit numerical game code
Organizer at that time has a “start game” button to start the game, or organizer can set a time that the game starts in their time zone
   1. If organizer wants to click “Start Game,” any player that is in the game will see a “Waiting for Organizer to Start the Game” screen
Leader board will be visible to Organizer
All game winners show up on the leader board in first game finish rank
Organizer has the discretion of choosing the number of winners for prizes

### Easy to Deploy

Use GitHub or other suitable actions to deploy to the server(s)

### Analytics

Track how many times a link has been opened, which would not show or display any identifying data about the user (e.g., GOOGLE analytics, etc.)

Below is a description of an example of how to host a bingo game while using a platform or system disclosed herein.
1. Access the game via the link in the digital Screen Play kit.
2. Enter your show details to create your unique game:
   Click the “Movie Start Time” box and select the show date and the time you plan to start the film (not the event's start time), then click “OK.”
   Select the time zone your showing is happening in from the “Show Time Zone” dropdown.
   Enter in your school name then select “Play Game.”
3. On your unique game homepage, a countdown, QR code and Game ID will appear for players to use to join the game.
   Adjust the start time by clicking the date/time box, enter your new time and hit “OK.” If the game has started, refresh the page to show the date/time box again for adjustments.
   After the start time passes, you only have five minutes to reset the time. After that, no changes can be made.
   Important: Keep your game homepage open or have the unique link accessible to manage start time adjustments, check the countdown, access the QR code and leaderboard, etc. If you exit and use the original link, it will start the process over and generate a new game and new QR code.
4. Share the QR code with the audience upon arrival or display it on a screen so they can join the game. Or have players join by visiting swankscreenplay.com and entering the six-digit Game ID.
   Tip: Make sure to print out the QR code and have it available for any students that arrive late so they can still join the fun.
5. Start the movie when the countdown reaches 00:00:00 to ensure the movie's time matches up with the timestamped questions in the game.
   Ensure no previews or ads play before the movie. If they do, skip ahead of these before your showing so you can start at the beginning of the movie when the clock hits 00:00:00.
   If you are unsure when the official start of the movie is, check out a digital version of the movie (either streaming or download). The start of these copies will be aligned with the start of the timestamps as long as there are no ads.
   Tip: Recommend using a digital download of the movie for synchronized timestamps and a smooth transition from the QR code to the movie.
6. Hosts can monitor the leaderboard on the game board or the game homepage.
   On the leaderboard, you may view player points and the order players have called Bingo (the number in the star that appears).
   Players can keep earning points even after they have called Bingo—the game is not over until the end of the movie.
   Tip: To keep players engaged until the end of the film, have prizes for the players with the most points and the first players to call Bingo.

Below is a description of example bingo game play instructions while using a platform or system disclosed herein.
1. Join the game using the QR code, or by entering the Game ID at www.swankscreenplay.com.
2. Enter a nickname and click “Join Game with Nickname.”
3. Read the instructions and click “Play.” The game will start automatically once the countdown ends. You can also preview your Bingo card by selecting the “Preview Game” button.
4. Click on a square when that box occurs in the film.
   Tip: Make sure to select the “Free” space.
5. Once you tap a square, either:
   Tap “Select” to mark it.
   Tap “Close” to exit the square.
6. If you select a square after the event occurs in the movie:
   It becomes activated.
   Points are based on timing: the closer you select the square to the event, the higher the points (range: 50-1,000). The free square awards 1,000 points.
7. If you select a square before the event:
   First time: you receive a warning.
   Subsequent times: 30-second penalty added to your game win time.
8. Once you have Bingo on your card (five squares in a row: horizontally, vertically or diagonally), a box will pop up for you to “Call Bingo.”
   If penalized during the game, you must wait for the penalty clock to reach “0” before you are able to officially call Bingo.
   Tip: Make sure you hit the button as quickly as possible to lock in your Bingo order.
9. After calling Bingo, you can select to continue playing to keep scoring points.
10. You can view the leaderboard and instructions at any time using the buttons at the bottom of the page.
   Once Bingo has been called, a star with a number will appear on the leaderboard next to the players name. This number is the order in which Bingo was called.

Below is a description of an example of how to host a trivia game while using a platform or system disclosed herein.
1. Access the game via the link in the digital Screen Play kit.
2. Enter your show details to create your unique game:
   Click the “Movie Start Time” box and select the show date and the time you plan to start the film (not the event's start time) then click “OK.”
   Select the time zone your showing is happening in from the “Show Time Zone” dropdown.
   Enter in your school name then select “Play Game.”
3. On your unique game homepage, a countdown, QR code and Game ID will appear for players to use to join the game.
   Adjust the start time by clicking the date/time box, enter your new time and hit “OK.” If the game has started, refresh the page to show the date/time box again for adjustments.
   After the start time passes, you only have five minutes to reset the time. After that, no changes can be made.
   Important: Keep your game homepage open or have the unique link accessible to manage start time adjustments, check the countdown, access the QR code and leaderboard, etc. If you exit and use the original link, it will start the process over and generate a new game and new QR code.
4. Share the QR code with the audience upon arrival or display it on a screen so they can join the game. Or have players join by visiting swankscreenplay.com and entering the six-digit Game ID.
   Tip: Make sure to print out the QR code and have it available for any students that arrive late so they can still join.
5. Start the movie when the countdown reaches 00:00:00 to ensure the movie's time matches up with the timestamped questions in the game.
   Ensure no previews or ads play before the movie. If they do, skip ahead of these before your showing so you can start at the beginning of the movie when the clock hits 00:00:00.
   If you are unsure when the official start of the movie is, check out a digital version of the movie (either streaming or download). The start of these copies will be aligned with the start of the timestamps as long as there are no ads.
   Tip: Recommend using a digital download of the movie for synchronized timestamps and a smooth transition from the QR code to the movie.
6. Hosts can monitor the leaderboard on the game board or the game homepage.
   Tip: To keep players engaged until the end of the film, have prizes for the players with the most points.

Below is a description of example trivia game play instructions while using a platform or system disclosed herein.
1. Join the game using the QR code, or by entering the Game ID at www.swankscreenplay.com.
2. Enter a nickname and click “Join Game with Nickname.”
3. Read the instructions and click “Play.” The game will start automatically once the countdown ends.
4. In between questions, you will see a countdown to when the next question will start.
   Tip: Turn off auto-lock on your phone, so your screen will stay lit and you will not miss any questions. And lower your screen brightness so you do not distract from the movie.
5. You can view the leaderboard and instructions at any time using the buttons at the bottom of the page. You can also see which question you are on in the game out of the total question count.
6. Once it is time for a question, you will see a preview of it with a countdown and then you will be able to answer it. After a question's time is up, you will see the correct answer (if applicable) or audience poll results, and then the updated game leaderboard.
7. There are four types of questions in the game. How points are won and point values vary based on the type of question, as does the timing for the question.
8A. Multiple Choice: You will see multiple answer options for the question. Select which one you think is the correct answer as quickly as possible to secure the most points. You can change your answer after you have selected one, but it will also change your possible points. You have 30 seconds to answer.
8B. Fill in the Blank: Form the correct answer using the selection of letters on the screen. Points are distributed for each correct letter in the correct spot. So even if you do not know, you are better off trying to answer instead of leaving it blank. You have 60 seconds to answer.
8C. Audience Polls: You will see multiple answer options, but there are no right or wrong answer-everyone gets the same points just for selecting one. See what the rest of the audience answered with poll results after the question. You have 30 seconds to answer.
8D. Free Answer: Type in your answer to the question in the box. There are no right or wrong answers-everyone gets the same points just for answering. You have 60 seconds to enter in your answer.
9. Stick around to the very end of the movie to see your final position on the leaderboard.

In some exemplary embodiments, the tech stack includes a C#website and C#Rest API, uses SQL Server for storage on a Windows Server, and utilizes Blazor Web Assembly as the Frontend for the website. Alternative embodiments may be configured differently with a different tech stack.

Disclosed are exemplary systems configured to be operable for providing time-based gaming experience(s) integrated/synchronized with media/movie/music event(s). The time-based gaming experience(s) may be integrated/synchronized with one or more of a movie screening, classroom presentation, auditory event, and/or visual presentation. In exemplary embodiments, the system is configured to enable one or more users to play a game on one or more mobile devices, which game is integrated/synchronized to the media/movie/music event. In exemplary embodiments, the system is configured to be operable for providing time-based gaming experience(s) integrated/synchronized with media/movie/music event(s) without requiring a dedicated app and/or on a login-free model accessible through a mobile web browser(s) without the need for a dedicated app.

In exemplary embodiments, the system is configured to be operable for offering real-time gaming experience(s) seamlessly integrated with media/movie/music event(s). The system may be configured to synchronize a gaming experience to a specific start time of the media/movie/music event to provide a synchronous mobile experience without controlling or initiating the media/movie/music content playback.

In exemplary embodiments, the system is configured to allow user(s) to participate in the games via a URL or QR code without requiring the user(s) to install any dedicated applications or create user accounts. The system may be configured to allow user(s) to join a game via a URL or QR code and to tailor the gaming experience to user preference(s). The system may be configured to anonymously identify game winner(s) and rankings thru a “nickname” moniker(s) entered into the system by the user(s) at the start of gameplay. The system may be configured to provide administrator(s) with a single uniform URL to deploy for multiple games that can run concurrently and asynchronously while tracking the progress of each game.

In exemplary embodiments, the system is configured to utilize pre-determined timecodes entered into the system to synchronize specific gaming events for players on their mobile devices, which events are pre-loaded into an Administration Web Interface for each type of game that can be deployed.

In exemplary embodiments, the system is configured to be operable in environments disconnected from and without the Internet, thereby enabling the system to be usable in closed networks and/or locations with little or no Internet connectivity, whereby the system is configured such that the only requirement is a Wi-Fi network to link gameplay.

In exemplary embodiments, the system is configured to capture saved games for determining how many players used the game at an event and their participation (though anonymous), which information may be usable as a return on investment (ROI) metric.

Disclosed are exemplary interactive media gaming platforms configured to be operable for providing time-based gaming experience(s) integrated/synchronized with media/movie/music event(s). The time-based gaming experience(s) may be integrated/synchronized with one or more of a movie screening, classroom presentation, auditory event, and/or visual presentation. In exemplary embodiments, the interactive media gaming platform is configured to enable one or more users to play a game on one or more mobile devices, which game is integrated/synchronized to the media/movie/music event. In exemplary embodiments, the interactive media gaming platform is configured to be operable for providing time-based gaming experience(s) integrated/synchronized with media/movie/music event(s) without requiring a dedicated app and/or on a login-free model accessible through a mobile web browser(s) without the need for a dedicated app.

In exemplary embodiments, the interactive media gaming platform is configured to be operable for offering real-time gaming experience(s) seamlessly integrated with media/movie/music event(s). The interactive media gaming platform may be configured to synchronize a gaming experience to a specific start time of the media/movie/music event to provide a synchronous mobile experience without controlling or initiating the media/movie/music content playback.

In exemplary embodiments, the interactive media gaming platform is configured to allow user(s) to participate in the games via a URL or QR code without requiring the user(s) to install any dedicated applications or create user accounts. The interactive media gaming platform may be configured to allow user(s) to join a game via a URL or QR code and to tailor the gaming experience to user preference(s). The interactive media gaming platform may be configured to anonymously identify game winner(s) and rankings thru a “nickname” moniker(s) entered into the interactive media gaming platform by the user(s) at the start of gameplay. The interactive media gaming platform may be configured to provide administrator(s) with a single uniform URL to deploy for multiple games that can run concurrently and asynchronously while tracking the progress of each game.

In exemplary embodiments, the interactive media gaming platform is configured to utilize pre-determined timecodes entered into the interactive media gaming platform to synchronize specific gaming events for players on their mobile devices, which events are pre-loaded into an Administration Web Interface for each type of game that can be deployed.

In exemplary embodiments, the interactive media gaming platform is configured to be operable in environments disconnected from and without the Internet, thereby enabling the interactive media gaming platform to be usable in closed networks and/or locations with little or no Internet connectivity, whereby the interactive media gaming platform is configured such that the only requirement is a Wi-Fi network to link gameplay.

In exemplary embodiments, the interactive media gaming platform is configured to capture saved games for determining how many players used the game at an event and their participation (though anonymous), which information may be usable as a return on investment (ROI) metric.

Disclosed are exemplary computer-implemented methods comprising providing time-based gaming experience(s) integrated/synchronized with media/movie/music event(s). The time-based gaming experience may be integrated/synchronized with one or more of a movie screening, classroom presentation, auditory event, and/or visual presentation. The computer-implemented method includes enabling one or more user(s) to play a game on one or more mobile device(s) that is integrated/synchronized to the media/movie/music event.

In exemplary embodiments, the computer-implemented method includes providing time-based gaming experience(s) integrated/synchronized with media/movie/music event(s) without requiring a dedicated app and/or on a login-free model accessible through a mobile web browser(s) without the need for a dedicated app.

In exemplary embodiments, the computer-implemented method includes offering real-time gaming experience(s) seamlessly integrated with media/movie/music event(s). The computer-implemented method may include synchronizing the gaming experience(s) to a specific start time of the media/movie/music event(s) to provide synchronous mobile experience(s) without controlling or initiating the media/movie/music content playback.

In exemplary embodiments, the computer-implemented method includes allowing user(s) to participate in the game(s) via a URL or QR code without requiring the user(s) to install any dedicated applications or create user accounts. The computer-implemented method may include allowing user(s) to join a game via a URL or QR code and to tailor their gaming experience(s) to user preference(s). The computer-implemented method may include anonymously identifying game winners and rankings thru a “nickname” moniker(s) entered by the user(s) at the start of gameplay. The computer-implemented method may include providing administrator(s) with a single uniform URL to deploy for multiple games that can run concurrently and asynchronously while tracking the progress of each game.

In exemplary embodiments, the computer-implemented method includes utilizing pre-determined timecodes entered on the computer-implemented method to synchronize specific gaming events for players on their mobile devices, which events are pre-loaded into an Administration Web Interface for each type of game that can be deployed.

In exemplary embodiments, the computer-implemented method includes providing time-based gaming experience(s) integrated/synchronized with media/movie/music event(s) in environment(s) disconnected from and without the Internet, including closed network(s) and/or location(s) with little or no Internet connectivity and with only a Wi-Fi network being required to link gameplay.

In exemplary embodiments, the computer-implemented method includes capturing saved games for determining how many players used the game at an event and their participation (though anonymous), which information may be usable as a return on investment (ROI) metric.

Exemplary non-transitory computer-readable storage media is disclosed that includes executable instructions, that when executed by at least one processor, cause the processor to be operable for providing time-based gaming experience(s) integrated/synchronized with media/movie/music event(s). The executable instructions include executable instructions, that when executed by the at least one processor, cause the processor to be operable for providing time-based gaming experience(s) integrated/synchronized with one or more of a movie screening, classroom presentation, auditory event, and/or visual presentation.

In exemplary embodiments of the non-transitory computer-readable storage media, the executable instructions include executable instructions, that when executed by the at least one processor, cause the processor to be operable for enabling one or more users to play a game on one or more mobile devices, which game is integrated/synchronized to the media/movie/music event.

In exemplary embodiments of the non-transitory computer-readable storage media, the executable instructions include executable instructions, that when executed by the at least one processor, cause the processor to be operable for providing time-based gaming experience(s) integrated/synchronized with media/movie/music event(s) without requiring a dedicated app.

In exemplary embodiments of the non-transitory computer-readable storage media, the executable instructions include executable instructions, that when executed by the at least one processor, cause the processor to be operable on a login-free model accessible through a mobile web browser(s) without the need for a dedicated app.

In exemplary embodiments of the non-transitory computer-readable storage media, the executable instructions include executable instructions, that when executed by the at least one processor, cause the processor to be operable for offering real-time gaming experience(s) seamlessly integrated with media/movie/music event(s). The executable instructions may include executable instructions, that when executed by the at least one processor, cause the processor to be operable to synchronize a gaming experience to a specific start time of the media/movie/music event to provide a synchronous mobile experience without controlling or initiating the media/movie/music content playback.

In exemplary embodiments of the non-transitory computer-readable storage media, the executable instructions include executable instructions, that when executed by the at least one processor, cause the processor to be operable for allowing user(s) to participate in the games via a URL or QR code without requiring the user(s) to install any dedicated applications or create user accounts. The executable instructions may include executable instructions, that when executed by the at least one processor, cause the processor to be operable for allowing user(s) to join a game via a URL or QR code and to tailor the gaming experience to user preference(s). The executable instructions may include executable instructions, that when executed by the at least one processor, cause the processor to be operable for providing administrator(s) with a single uniform URL to deploy for multiple games that can run concurrently and asynchronously while tracking the progress of each game. The executable instructions may include executable instructions, that when executed by the at least one processor, cause the processor to be operable for anonymously identifying game winner(s) and rankings thru a “nickname” moniker(s) entered into the interactive media gaming platform by the user(s) at the start of gameplay.

In exemplary embodiments of the non-transitory computer-readable storage media, the executable instructions include executable instructions, that when executed by the at least one processor, cause the processor to be operable for utilizing pre-determined timecodes entered to synchronize specific gaming events for players on their mobile devices, which events are pre-loaded into an Administration Web Interface for each type of game that can be deployed.

In exemplary embodiments of the non-transitory computer-readable storage media, the executable instructions include executable instructions, that when executed by the at least one processor, cause the processor to be operable in environments disconnected from and without the Internet, in closed networks, and/or in locations with little or no Internet connectivity, such that the only requirement is a Wi-Fi network to link gameplay.

In exemplary embodiments of the non-transitory computer-readable storage media, the executable instructions include executable instructions, that when executed by the at least one processor, cause the processor to be operable for capturing saved games for determining how many players used the game at an event and their participation (though anonymous), which information may be usable as a return on investment (ROI) metric.

In an exemplary embodiment, an interactive media gaming platform or system configured to be operable for providing time-based gaming experience(s) integrated/synchronized with media/movie/music event(s). The interactive media gaming platform or system is configured to enable one or more users to play a game on one or more mobile devices, which game is integrated/synchronized to the media/movie/music event. The interactive media gaming platform or system is configured to be operable on a login-free model accessible through a mobile web browser(s) without requiring a dedicated app. The interactive media gaming platform is configured to be operable for offering real-time gaming experience(s) seamlessly integrated with media/movie/music event(s). The interactive media gaming platform or system is configured to be operable in an environment(s) disconnected from and without the Internet, thereby enabling the interactive media gaming platform or system to be usable in a closed network(s) and/or location(s) with little or no Internet connectivity, whereby the interactive media gaming platform or system is configured to allow gameplay to be linked over a Wi-Fi network without Internet connectivity. The interactive media gaming platform or system is configured to capture saved games for determining how many players used the game at an event and their participation (though anonymous), which information is usable as a return on investment (ROI) metric. The interactive media gaming platform is usable for providing time-based gaming experience(s) integrated/synchronized with one or more of a movie screening, classroom presentation, auditory event, and/or visual presentation. The interactive media gaming platform or system is configured to synchronize a gaming experience to a specific start time of the media/movie/music event to provide a synchronous mobile experience without controlling or initiating the media/movie/music content playback. The interactive media gaming platform or system is configured to allow user(s) to participate in the games via a URL or QR code without requiring the user(s) to install any dedicated applications or create user accounts. The interactive media gaming platform or system is configured to allow user(s) to join a game via a URL or QR code and to tailor the gaming experience to user preference(s). The interactive media gaming platform or system is configured to anonymously identify game winner(s) and rankings thru a “nickname” moniker(s) entered into the interactive media gaming platform by the user(s) at the start of gameplay. The interactive media gaming platform or system is configured to provide administrator(s) with a single uniform URL to deploy for multiple games that can run concurrently and asynchronously while tracking the progress of each game. The interactive media gaming platform or system is configured to utilize pre-determined timecodes entered into the interactive media gaming platform to synchronize specific gaming events for players on their mobile devices, which events are pre-loaded into an Administration Web Interface for each type of game that can be deployed.

In an exemplary embodiment, a computer-implemented method includes: enabling one or more user(s) to play a game on one or more mobile device(s) that is integrated/synchronized to the media/movie/music event; providing time-based gaming experience(s) integrated/synchronized with media/movie/music event(s) on a login-free model accessible through a mobile web browser(s) without requiring a dedicated app; offering real-time gaming experience(s) seamlessly integrated with media/movie/music event(s); providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity; capturing saved games for determining how many players used the game at an event and their participation (though anonymous), which information is usable as a return on investment (ROI) metric; synchronizing the gaming experience(s) to a specific start time of the media/movie/music event(s) to provide synchronous mobile experience(s) without controlling or initiating the media/movie/music content playback; allowing user(s) to participate in the game(s) via a URL or QR code without requiring the user(s) to install any dedicated applications or create user accounts; allowing user(s) to join a game via a URL or QR code and to tailor their gaming experience(s) to user preference(s); anonymously identifying game winners and rankings thru a “nickname” moniker(s) entered by the user(s) at the start of gameplay; providing administrator(s) with a single uniform URL to deploy for multiple games that can run concurrently and asynchronously while tracking the progress of each game; and utilizing pre-determined timecodes entered on the computer-implemented method to synchronize specific gaming events for players on their mobile devices, which events are pre-loaded into an Administration Web Interface for each type of game that can be deployed.

In an exemplary embodiment, a non-transitory computer-readable storage media comprising executable instructions, that when executed by at least one processor, cause the processor to be operable for providing time-based gaming experience(s) integrated/synchronized with media/movie/music event(s). The executable instructions include executable instructions, that when executed by the at least one processor, cause the processor to be operable for: enabling one or more user(s) to play a game on one or more mobile device(s) that is integrated/synchronized to the media/movie/music event; providing time-based gaming experience(s) integrated/synchronized with media/movie/music event(s) on a login-free model accessible through a mobile web browser(s) without requiring a dedicated app; offering real-time gaming experience(s) seamlessly integrated with media/movie/music event(s); providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity; capturing saved games for determining how many players used the game at an event and their participation (though anonymous), which information is usable as a return on investment (ROI) metric; providing a time-based gaming experience(s) integrated/synchronized with one or more of a movie screening, classroom presentation, auditory event, and/or visual presentation; for synchronizing a gaming experience to a specific start time of the media/movie/music event to provide a synchronous mobile experience without controlling or initiating the media/movie/music content playback; allowing user(s) to participate in the games via a URL or QR code without requiring the user(s) to install any dedicated applications or create user accounts; allowing user(s) to join a game via a URL or QR code and to tailor the gaming experience to user preference(s); anonymously identifying game winner(s) and rankings thru a “nickname” moniker(s) entered into the interactive media gaming platform by the user(s) at the start of gameplay; providing administrator(s) with a single uniform URL to deploy for multiple games that can run concurrently and asynchronously while tracking the progress of each game; and utilizing pre-determined timecodes entered to synchronize specific gaming events for players on their mobile devices, which events are pre-loaded into an Administration Web Interface for each type of game that can be deployed.

Advantageously, exemplary embodiments disclosed herein may be implemented to create one-of-a-kind interactive events in which participants (e.g., students, etc.) play themed games on their phones while watching a movie. With a live leaderboard and multiple ways to earn points, the digital games keep the participants engaged and enhance the overall experience. For example, exemplary embodiments disclosed herein may be implemented to provide an enjoyable twist to a classic bingo game in which the participants mark board spaces featuring plot points and quotes on their phone as they occur in the movie. During the digital bingo, the participants try to get bingo first while earning points for speedy answers, ensuring continuous engagement and multiple ways to win. By way of further example, exemplary embodiments disclosed herein may be implemented for digital trivia in which participants (e.g., students, etc.) answer questions related to plot points as they occur in the movie. Points are awarded based on how quickly the participants identify the correct answer, adding another layer of excitement to the screening.

As will be appreciated based on the foregoing specification, the above-described embodiments of the disclosure may be implemented using computer programming or engineering techniques including computer software, firmware, hardware, or any combination or subset thereof. Exemplary embodiments may include one or more processors and memory coupled to (and in communication with) the one or more processors. A processor may include one or more processing units (e.g., in a multi-core configuration, etc.) such as, and without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

It should be appreciated that the functions described herein, in some embodiments, may be described in computer executable instructions stored on a computer readable media, and executable by at least one processor. The computer readable media is a non-transitory computer readable storage medium. By way of example, and not limitation, such computer-readable media can include dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, other optical disk storage, magnetic disk storage or other magnetic storage devices, any other type of volatile or nonvolatile physical or tangible computer-readable media, or other medium that can be used to carry or store desired program code in the form of instructions or data structures and that can be accessed by a computer. Combinations of the above should also be included within the scope of computer-readable media.

Computer-executable instructions may be stored in the memory for execution by a processor to particularly cause the processor to perform one or more of the functions described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the functions or processes described herein.

It should also be appreciated that one or more aspects of the present disclosure transform a general-purpose computing device into a special-purpose computing device when configured to perform the functions, methods, and/or processes described herein.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific time limits, dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within tolerances.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An interactive media gaming platform or system configured to be operable for providing time-based gaming experience(s) integrated/synchronized with media/movie/music event(s), wherein:
the interactive media gaming platform or system is configured to capture saved games for determining how many players used a game at an event and their participation (though anonymous), which information is usable as a return on investment (ROI) metric; and
the interactive media gaming platform or system is configured to allow user(s) to participate in game(s) via a URL or QR code without requiring the user(s) to install any dedicated applications or create user accounts; and
the interactive media gaming platform or system is configured to provide administrator(s) with a single uniform URL to deploy for multiple games that can run concurrently and asynchronously while tracking the progress of each game; and
the interactive media gaming platform or system is configured to anonymously identify game winner(s) and rankings thru a “nickname” moniker(s) entered into the interactive media gaming platform by the user(s) at the start of gameplay.

2. The interactive media gaming platform or system of claim 1, wherein:
the interactive media gaming platform or system is configured to enable one or more users to play a game on one or more mobile devices, which game is integrated/synchronized to a media/movie/music event; and/or
the interactive media gaming platform or system is configured to be operable on a login-free model accessible through a mobile web browser(s) and/or without requiring installation of a dedicated application; and/or
the interactive media gaming platform is configured to be operable for offering real-time gaming experience(s) synchronized and seamlessly integrated with media/movie/music event(s) being presented.

3. The interactive media gaming platform or system of claim 1, wherein:
the interactive media gaming platform or system is configured to enable one or more users to play a game on one or more mobile devices, which game is integrated/synchronized to the media/movie/music event; and
the interactive media gaming platform or system is configured to be operable on a login-free model accessible through a mobile web browser(s) and/or without requiring installation of a dedicated application; and
the interactive media gaming platform is configured to be operable for offering real-time gaming experience(s) synchronized and seamlessly integrated with media/movie/music event(s) being presented; and
the interactive media gaming platform or system is configured to be operable in an environment(s) disconnected from and without the Internet, thereby enabling the interactive media gaming platform or system to be usable in a closed network(s) and/or location(s) with little or no Internet connectivity, whereby the interactive media gaming platform or system is configured to allow gameplay to be linked over a Wi-Fi network without Internet connectivity; and
the interactive media gaming platform or system is configured to synchronize a gaming experience to a specific start time of the media/movie/music event to provide a synchronous mobile experience without controlling or initiating the media/movie/music content playback.

4. The interactive media gaming platform or system of claim 1, wherein the interactive media gaming platform or system is configured to be operable in an environment(s) disconnected from and without the Internet, thereby enabling the interactive media gaming platform or system to be usable in a closed network(s) and/or location(s) with little or no Internet connectivity, whereby the interactive media gaming platform or system is configured to allow gameplay to be linked over a Wi-Fi network without Internet connectivity.

5. The interactive media gaming platform or system of claim 1, wherein the interactive media gaming platform is usable for providing time-based gaming experience(s) integrated/synchronized with one or more of a movie screening, classroom presentation, auditory event, and/or visual presentation.

6. The interactive media gaming platform or system of claim 1, wherein the interactive media gaming platform or system is configured to synchronize a gaming experience to a specific start time of the media/movie/music event to provide a synchronous mobile experience without controlling or initiating the media/movie/music content playback.

7. The interactive media gaming platform or system of claim 1, wherein the interactive media gaming platform or system is configured to utilize pre-determined timecodes entered into the interactive media gaming platform to synchronize specific gaming events for players on their mobile devices, which events are pre-loaded into an Administration Web Interface for each type of game that can be deployed.

8. The interactive media gaming platform or system of claim 1, wherein:
the interactive media gaming platform or system is configured to be operable for providing a network-based gaming environment in which various forms of media are synchronized with interactive gameplay features accessible on mobile devices; and/or
the interactive media gaming platform or system is configured to be implemented using a wireless network including the Internet or a closed Wi-Fi network and end user(s) have access to the media at a specified time; and/or
the interactive media gaming platform or system is configured to be device-agnostic thereby allowing end user(s) to use a smartphone with a standard web browser without requiring a dedicated application download or user login; and/or
the interactive media gaming platform or system comprises a synchronized, event-driven gaming system or platform configured to be operable for integrating interactive gameplay with concurrently presented media content.

9. The interactive media gaming platform or system of claim 1, wherein:
the interactive media gaming platform or system is configured to be operable for providing a network-based gaming environment in which various forms of media are synchronized with interactive gameplay features accessible on mobile devices; and
the interactive media gaming platform or system is configured to be implemented using a wireless network including the Internet or a closed Wi-Fi network and end user(s) have access to the media at a specified time; and
the interactive media gaming platform or system is configured to be device-agnostic thereby allowing end user(s) to use a smartphone with a standard web browser without requiring a dedicated application download or user login; and
the interactive media gaming platform or system comprises a synchronized, event-driven gaming system or platform configured to be operable for integrating interactive gameplay with concurrently presented media content.

10. A computer-implemented method comprising providing time-based gaming experience(s) integrated/synchronized with media/movie/music event(s), wherein the computer-implemented method further includes:
capturing saved games for determining how many players used a game at an event and their participation (though anonymous), which information is usable as a return on investment (ROI) metric; and
allowing user(s) to participate in game(s) via a URL or QR code without requiring the user(s) to install any dedicated applications or create user; and
anonymously identifying game winners and rankings thru a “nickname” moniker(s) entered by the user(s) at the start of gameplay; and
providing administrator(s) with a single uniform URL to deploy for multiple games that can run concurrently and asynchronously while tracking the progress of each game.

11. The computer-implemented method of claim 10, wherein the computer-implemented method includes:
enabling one or more user(s) to play a game on one or more mobile device(s) that is integrated/synchronized to a media/movie/music event; and/or
providing time-based gaming experience(s) integrated/synchronized with media/movie/music event(s) on a login-free model accessible through a mobile web browser(s) and/or without requiring installation of a dedicated application; and/or
offering real-time gaming experience(s) synchronized and seamlessly integrated with media/movie/music event(s) being presented.

12. The computer-implemented method of claim 10, wherein the computer-implemented method includes:
enabling one or more user(s) to play a game on one or more mobile device(s) that is integrated/synchronized to the media/movie/music event; and
providing time-based gaming experience(s) integrated/synchronized with media/movie/music event(s) on a login-free model accessible through a mobile web browser(s) and/or without requiring installation of a dedicated application; and
offering real-time gaming experience(s) synchronized and seamlessly integrated with media/movie/music event(s) being presented; and
providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity; and
synchronizing the gaming experience(s) to a specific start time of the media/movie/music event(s) to provide synchronous mobile experience(s) without controlling or initiating the media/movie/music content playback.

13. The computer-implemented method of claim 10, wherein the computer-implemented method includes providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity.

14. The computer-implemented method of claim 10, wherein the computer-implemented method includes providing a time-based gaming experience integrated/synchronized with one or more of a movie screening, classroom presentation, auditory event, and/or visual presentation.

15. The computer-implemented method of claim 10, wherein the computer-implemented method includes synchronizing the gaming experience(s) to a specific start time of the media/movie/music event(s) to provide synchronous mobile experience(s) without controlling or initiating the media/movie/music content playback.

16. The computer-implemented method of claim 10, wherein the computer-implemented method includes utilizing pre-determined timecodes entered on the computer-implemented method to synchronize specific gaming events for players on their mobile devices, which events are pre-loaded into an Administration Web Interface for each type of game that can be deployed.

17. The computer-implemented method of claim 10, wherein the method includes:
providing a network-based gaming environment in which various forms of media are synchronized with interactive gameplay features accessible on mobile devices; and/or
using a wireless network including the Internet or a closed Wi-Fi network to implement the time-based gaming experience(s) integrated/synchronized with the media/movie/music event(s) and end user(s) have access to the media/movie/music event(s) at a specified time; and/or
integrating interactive gameplay with concurrently presented media content.

18. A non-transitory computer-readable storage media comprising executable instructions, that when executed by at least one processor, cause the processor to be operable for providing time-based gaming experience(s) integrated/synchronized with media/movie/music event(s), wherein the executable instructions include:
executable instructions, that when executed by the at least one processor, cause the processor to be operable for capturing saved games for determining how many players used a game at an event and their participation (though anonymous), which information is usable as a return on investment (ROI) metric; and
executable instructions, that when executed by the at least one processor, cause the processor to be operable for allowing user(s) to participate in game(s) via a URL or QR code without requiring the user(s) to install any dedicated applications or create user accounts; and
executable instructions, that when executed by the at least one processor, cause the processor to be operable for anonymously identifying game winner(s) and rankings thru a “nickname” moniker(s) entered into the interactive media gaming platform by the user(s) at the start of gameplay; and
executable instructions, that when executed by the at least one processor, cause the processor to be operable for providing administrator(s) with a single uniform URL to deploy for multiple games that can run concurrently and asynchronously while tracking the progress of each game.

19. The non-transitory computer-readable storage media of claim 18, wherein the executable instructions include:
executable instructions, that when executed by the at least one processor, cause the processor to be operable for enabling one or more user(s) to play a game on one or more mobile device(s) that is integrated/synchronized to a media/movie/music event; and/or
executable instructions, that when executed by the at least one processor, cause the processor to be operable for providing time-based gaming experience(s) integrated/synchronized with media/movie/music event(s) on a login-free model accessible through a mobile web browser(s) and/or without requiring installation of a dedicated application; and/or
executable instructions, that when executed by the at least one processor, cause the processor to be operable for offering real-time gaming experience(s) synchronized and seamlessly integrated with media/movie/music event(s) being presented.

20. The non-transitory computer-readable storage media of claim 18, wherein the executable instructions include:
executable instructions, that when executed by the at least one processor, cause the processor to be operable for enabling one or more user(s) to play a game on one or more mobile device(s) that is integrated/synchronized to the media/movie/music event; and
executable instructions, that when executed by the at least one processor, cause the processor to be operable for providing time-based gaming experience(s) integrated/synchronized with media/movie/music event(s) on a login-free model accessible through a mobile web browser(s) and/or without requiring installation of a dedicated application; and
executable instructions, that when executed by the at least one processor, cause the processor to be operable for offering real-time gaming experience(s) synchronized and seamlessly integrated with media/movie/music event(s) being presented; and
executable instructions, that when executed by the at least one processor, cause the processor to be operable for providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity; and
executable instructions, that when executed by the at least one processor, cause the processor to be operable to synchronize a gaming experience to a specific start time of the media/movie/music event to provide a synchronous mobile experience without controlling or initiating the media/movie/music content playback.

21. The non-transitory computer-readable storage media of claim 18, wherein the executable instructions include executable instructions, that when executed by the at least one processor, cause the processor to be operable for providing time-based gaming experience(s) integrated/synchronized with media/movie/music event(s) in an environment(s) disconnected from and without the Internet, including a closed network(s) and/or location(s) with little or no Internet connectivity whereby gameplay is linkable over a Wi-Fi network without Internet connectivity.

22. The non-transitory computer-readable storage media of claim 18, wherein the executable instructions include executable instructions, that when executed by the at least one processor, cause the processor to be operable for providing a time-based gaming experience(s) integrated/synchronized with one or more of a movie screening, classroom presentation, auditory event, and/or visual presentation.

23. The non-transitory computer-readable storage media of claim 18, wherein the executable instructions include executable instructions, that when executed by the at least one processor, cause the processor to be operable to synchronize a gaming experience to a specific start time of the media/movie/music event to provide a synchronous mobile experience without controlling or initiating the media/movie/music content playback.

24. The non-transitory computer-readable storage media of claim 18, wherein the executable instructions include executable instructions, that when executed by the at least one processor, cause the processor to be operable for utilizing pre-determined timecodes entered to synchronize specific gaming events for players on their mobile devices, which events are pre-loaded into an Administration Web Interface for each type of game that can be deployed.

25. A platform or system comprising the at least one processor and the non-transitory computer-readable storage media of claim 18 that includes the instructions that when executed by at least one processor, cause the platform or system to be operable for providing time-based gaming experience(s) integrated/synchronized with media/movie/music event(s).

26. A synchronized, event-driven gaming system or platform comprising the at least one processor and the non-transitory computer-readable storage media of claim 18 such that the synchronized, event-driven gaming system or platform is configured to be operable for integrating interactive gameplay with concurrently presented media content.
